(19) United States
(12) Patent Application Publication
(10) Pub. No.: US 2024/0216929 A1
(43) Pub. Date: Jul. 4, 2024

(54) An Apparatus and Process for Complete Treatment of Slurry and Powder

(71) Applicant: Shreepad Hegde, Hyderabad (IN)

(72) Inventor: Shreepad Hegde, Hyderabad (IN)

(21) Appl. No.: 18/572,852

(22) PCT Filed: Jun. 21, 2022
(86) PCT No.: PCT/IB2022/055742

§ 371 Date: Dec. 21, 2023

(30) Foreign Application Priority Data
Jun. 22, 2021 (IN) 202141028033

(51) Int. Cl. B04B 3/00; B04B 11/08; F26B 3/24; F26B 5/08; F26B 21/14; F26B 25/00; F26B 25/04

(52) U.S. Cl. CPC B04B 3/00; B04B 11/08; F26B 3/24; F26B 5/08; F26B 21/14; F26B 25/002; F26B 25/04; F26B 2200/08; F26B 2200/18

(57) ABSTRACT

Implemented is an apparatus and a process for complete treatment of slurry and powder. The apparatus includes a rotatable lower bowl assembly, a rotatable upper bowl assembly adapted to be assembled with the lower bowl assembly, a drive including at least a geared motor, connected with each of the lower bowl assembly and the upper bowl assembly. A main frame assembly movably mounts the lower bowl assembly and the upper bowl assembly. The lower bowl assembly and the upper bowl assembly are assembled together to form a spherical bowl assembly in a vertical orientation, on the main frame assembly. The spherical bowl assembly receives the slurry for treatment, processes the slurry into a dried product after treatment, and safely discharges the dried product out of the spherical bowl assembly.

### CROSS-REFERENCES TO RELATED APPLICATIONS

This Non-Provisional Utility Patent application claims the benefit of and priority to PCT Application Serial No. PCT/IB2022/055742, filed Jun. 21, 2022, entitled “An Apparatus and Process for Complete Treatment of Slurry and Powder,” which claims the benefit of and priority to Indian Patent Application Serial No. 202141028033, filed Jun. 22, 2021, entitled “An Apparatus and Process for Complete Treatment of Slurry and Powder,” the entire contents of both applications of which are hereby incorporated herein by reference.

### FIELD OF THE INVENTION

Embodiments of the present invention generally relate to systems and apparatuses involving filtering, drying, milling, sieving and packing etc. of solids, liquids or mixture thereof, and more particularly to an apparatus and process for complete treatment of slurry and powder, in a single integrated apparatus.

### BACKGROUND

A slurry is a mixture of densor solids suspended in liquid. The most common use of slurry is as a means of transporting solids. The size of solid particles may vary up to hundreds of millimeters. The processing of slurry to separate the solid particles from the liquid is one of the most important aspect in various industries such as pharmaceuticals, chemical, fertilizer and food etc. Several independent steps are involved in processing the slurry to its final stage, such as, but not limited to, filtering, drying, milling, sieving and packing etc. Each of these processes requires a specific machine on which it can be performed. Some of the commonly required machines/apparatus have been explained below:

Centrifuge (CF): Widely used equipment in the industry for solid liquid separation. The centrifuge uses very high centrifugal force to separate solid from liquid. There are two concentric cylindrical bowls. Internal perforated bowl with filter cloth is rotated at very high speed rotation with the slurry. Very high centrifugal force developed due to high speed rotation, pushes the liquid out of the filter bag and traps the solid inside. There are various types of CF that are available in the market—horizontal bowl and vertical bowl.

Disadvantage: Though to the large extent the liquid is separated from the solids, It cannot dry the solid. In this equipment drying, milling and sieving is not possible. CF being open operation, containment operation is not possible. Unloading of the wet cake is mostly manual and open operation. Operator is exposed to hazardous vapors and dust (particulate matter).

Agitated Nutsche Filter Dryer (ANFD): ANFD is used in the industry for separation of solids from liquid and drying. ANFD use vacuum for separation. Slurry is fed over filter plate and vacuum is applied below the filter plate. The slurry is continuously agitated to avoid stagnation. Due to vacuum the liquid is sucked out and solid is retained over the filter plate. The steam is circulated in the jacket of the ANFD to heat the wet mass. The solid is dried and discharged in closed condition.

Disadvantage: Though the process is normally closed but exposed during discharged. ANFD cannot be used where the slurry is very sticky and demands very high separation force.

Co-Milling: Co-mill is used for particle size reduction and then sieve it to get uniform particle size. Milling and sieving is carried out in single equipment. Comill is used after the solid liquid separation and drying of the solids.

Tray Drier: Tray drier uses indirect heating method. The wet material is loaded onto a tray. Then this tray is placed on hollow plate in a vacuum chamber. This hollow plate is heated by electrical heater or hot water/steam circulation etc. The material is thus heated indirectly under vacuum.

The try drier is used for vacuum drying of wet material. The material is dried at low temperature under vacuum. The vacuum reduces the boiling point of the liquid and thus evaporates at lower temperature. This is especially suitable when the solid is unstable at higher temperature.

Rotary Cone Vacuum Drier: The rotary cone vacuum drier also uses vacuum drying technique. It is a double cone vessel with heating jacket. The double cone vessel is slowly rotated during drying giving tumbling effect. The vacuum is maintained inside to reduce the boiling point of the liquid. This is very effective way of drying with tumbling and vacuum at low temperature.

However, as already mentioned, all these processes are required to be performed on dedicated independent machines sequentially. For example: The slurry is first fed into centrifuge, the centrifuged wet solid is then fed into tray drier, dried material is then fed into miller and then to sifter etc. So, it will be understood by a skilled addressee that there will be a loss of material during transfer of material from one machine to the other. It may release gases and vapors during operation. Needless to say, performing all the above processes on different machines is a time and labour intensive process, involves human intervention at every stage.

Additionally, the materials handled may be toxic, therefore hazardous to human health and to environment. So, handling becomes very important, say, handling needs to be done in completely closed environment and under controlled atmosphere. The production has to be handled under Inert atmosphere and under controlled temperature and humidity. However, very little solution is available at the moment as multiple machines are involved.

Hence, there exists a need for an apparatus and process for complete treatment of slurry and powder, in a single integrated apparatus that does not suffer from the above-mentioned deficiencies or at least provides a viable and effective alternative.

### SUMMARY

The object of the present invention is to provide an apparatus and process for complete treatment of slurry and powder, in a single integrated apparatus.

Another object of the invention is to provide an integrated apparatus for performing operations such as filtration, drying, milling, sieving and packing, with minimal human intervention.

Another object of the invention is to provide an integrated apparatus for complete treatment of slurry, under controlled atmosphere.

Another object of the invention is to provide an integrated apparatus for complete treatment of the slurry with minimum exposure of the product to the human or environment.

Another object of the invention is to provide an automatic or semi-automatic, recipe based or remotely operated apparatus for complete processing of slurry.

Another object of the invention is to centrifuge the slurry in closed and controlled atmosphere.

Another object of the invention is to delump the wet cake after centrifuging the slurry.

Another object of the invention is to dry the wet cake under controlled atmosphere and/or under vacuum.

Another object of the invention is to mill and sieve the dry product under controlled atmosphere.

Another object of the invention is to pack and dispose the product after treatment of slurry under containment.

Embodiments of the present invention, provide an apparatus for complete treatment of slurry and powder. The apparatus comprises a rotatable lower bowl assembly; an upper bowl assembly adapted to be assembled with the lower bowl assembly; a drive including atleast a geared motor, connected with each of the lower bowl assembly and the upper bowl assembly; and a main frame assembly to movably mount the lower bowl assembly and the upper bowl assembly coupled together to form a spherical bowl assembly in a vertical orientation. Herein, the spherical bowl assembly is adapted to receive the slurry for treatment via the lower bowl assembly, processing the slurry into a dried product after treatment, and discharge the dried product out of the spherical bowl assembly in a completely closed and contained manner without any exposure to the operator or to the environment.

In accordance with an embodiment of the present invention, the lower bowl assembly includes a drain bowl, a filtration bowl, a cake cutter, drain nozzles, and utility nozzles. Herein, the drain bowl is mounted on the mainframe assembly and is adapted to house the filtration bowl. Further, the drain bowl is provided with the drain nozzle configured to drain a mother liquor, and the utility nozzle is configured to apply vacuum/Nitrogen, any other gas or water etc., during drying and cleaning.

In accordance with an embodiment of the present invention, the drive associated with lower bowl assembly includes a first geared motor connected with the filtration bowl and a reciprocating cylinder connected with a cake cutter is mounted on the drain bowl. Further, the first geared motor is configured to rotate the filtration bowl at variable speeds depending on the requirement. Also, the cake cutter has a cutting blade at edges to scrape the wet cake of solids separated from slurry, deposited on the filtration bowl. Additionally, the cake cutter is configured to move radially with reciprocating motion of the reciprocating cylinder and the scraping or cutting action is performed by a slow rotation of filtration bowl when the cake cutter blade is moved radially.

In accordance with an embodiment of the present invention, the upper bowl assembly includes a drying bowl, an agitator, a chopper, a discharge nozzle, a comill and utility nozzles selected from a nitrogen or vacuum nozzle or any other gas or water and a sampling nozzle. Herein, the drying bowl together with the agitator is designed for complete discharge of a dried product, whereby the agitator is configured to press the wet mass during drying operation and push the dried material towards the discharge nozzle during the discharge operation. In addition, the chopper is configured to be driven by a second gear motor and the agitators are configured to be driven by a third geared motor mounted outside the drying bowl at variable speeds. Moreover, a discharge valve is provided at the discharge nozzle to control a product discharge rate.

In accordance with an embodiment of the present invention, the upper bowl assembly comprises a view glass and a digital camera system may be provided for checking of the complete discharge of the dried product.

In accordance with an embodiment of the present invention, the main frame assembly includes a main frame, that mounts an linear motion (LM) guide, and a lead screw. Herein, the lead screw is adapted to be driven by a fifth geared motor. Additionally, the LM guide and the lead screw along with fifth geared motor are connected to the upper bowl assembly. Further, when upper bowl and lower bowls are assembled together, the entire spherical bowl assembly is enabled to move up and down on the main frame. Also, the lead screw is also configured to lift the drying bowl of the upper bowl assembly, independently of the drain bowl of the lower bowl assembly.

In accordance with an embodiment of the present invention, a sixth geared motor is also provided on the main frame on an opposite side of the fifth geared motor, and is connected to the lower bowl assembly. Herein, the sixth geared motor is designed to rotate the spherical bowl assembly along its axis at low speed. Also, weight measuring load cells are provided at a bottom of the main frame for measuring of weight of the spherical bowl assembly.

In accordance with an embodiment of the present invention, the apparatus further comprises a control panel provided with a programmable logic; a cleaning spray ball assembly provided to wash the entire spherical bowl assembly; and a flow meter provided in a slurry line and also in a drain line.

According to another aspect of the present invention, there is provided a process for complete treatment of slurry using the apparatus described above. The process comprises assembling the drying bowl over the drain bowl firmly using the quick release coupling, to form the spherical bowl assembly in a vertical orientation; moving the spherical bowl assembly in the vertical orientation to the bottom most position on the main frame; closing all the valves and feeding nitrogen inside the spherical bowl assembly to ensure inertisation; rotating the filtration bowl at low or medium speed, while feeding the slurry into it; pushing the slurry towards the wall of the filtration bowl and separating it into solids and liquids, under an influence of a centrifugal force generated by rotation; causing the liquid filtrate to flow out of the filtration bowl into the drain bowl and then drained out through drain nozzle; causing the solids to form a wet cake start getting collected in a layer by layer form on an inside surface of the filtration bowl; adding a solvent in the filtration bowl while rotating at low speed to wash the wet cake and then draining the solvent out of the filtration bowl after washing; and moving the filtration bowl with very low speed to allow the cake cutter disposed therein to move slowly and radially outward to scrape the wet cake in a layer by layer manner.

In accordance with an embodiment of the present invention, the process further comprises rotating the spherical bowl assembly upside down, thereby bringing the drain bowl to the upper position and the drying bowl to the bottom position; dumping or unloading the wet cake from the filtration bowl into the drying bow; heating the drying bowl with hot water circulation in the jacket or limpet coil and simultaneously starting the agitator and the chopper to ensure that the wet mass of the cake is heated, agitated, and the lumps are chopped; opening a vacuum nozzle to remove vapour generated during drying, while maintaining a nitrogen blanket; ensuring a vacuum inside the drying bowl to reduce the boiling temperature of the solvent so that the drying takes place quickly and effectively, to form a dried product; lifting the spherical bowl assembly is upwards to a predetermined height on the main frame, rotated and positioned in a way that the discharge nozzle is positioned directly downwards; starting the comill while slowly opening the discharge valve to cause the dried product to flow out into the comill through the discharge valve; and collecting the discharged product in powdered form in a continuous liner bag for weighing and packing, thereby completing the treatment of slurry in a completely closed and contained manner without any exposure to the operator or to the environment.

### BRIEF DESCRIPTION OF THE DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein:

FIG. 1 illustrates an apparatus (10) for complete treatment of slurry and powder, in accordance with an embodiment of the present invention;

FIG. 2A-2D illustrate multiple views of a lower bowl assembly, in accordance with an embodiment of the present invention;

FIG. 3A-3D illustrate multiple views of an upper bowl assembly (200), in accordance with an embodiment of the present invention; and

FIG. 4A-4C illustrate multiple views of the main frame assembly (300), in accordance with an embodiment of the present invention.

### DETAILED DESCRIPTION

While the present invention is described herein by way of example using embodiments, those skilled in the art will recognize that the invention is not limited to the embodiments described herein. It should be understood that the description herein is not intended to limit the invention to the particular form disclosed, but on the contrary, the invention is to cover all modification/s, equivalent/s and alternative/s falling within the scope of the present invention. The headings used herein are for organizational purposes only and are not meant to be used to limit the scope of the description or the claim. As used throughout this description, the word “may” be used in a permissive sense (i.e., meaning having the potential to), rather than the mandatory sense (i.e., meaning must). Further, the words “a” or “an” means “at least one” unless otherwise mentioned. Furthermore, the terminology and phraseology used herein is solely used for descriptive purposes and should not be construed as limiting in scope. Language such as “including”, “comprising”, “having”, “containing”, or “involving” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the likes are included in the specification solely for the purpose of providing a context for the present invention. It is not suggested or represented that any or all these matters form part of the prior art base or were common general knowledge in the field relevant to the present invention.

In this disclosure, whenever an element or a group of elements is preceded with the transitional phrase “comprising”, it is understood that we also contemplate the same composition, element or group of elements with transitional phrases “consisting of”, “consisting”, “selected from the group of consisting of”, “including”, or “is” preceding the recitation of the composition, element or group of elements and vice versa.

This invention described herein may be embodied in many different forms and should not be construed as limited to the embodiment set forth herein. Rather, the embodiments are provided so that this disclosure will be thorough and complete and will fully convey the scope of the invention to those skilled in the art. In the following description, numeric values and ranges are provided for various aspects of the implementations described. These values and ranges are to be treated as examples only and are not intended to limit the scope of the claims. In addition, a number of materials are identified as suitable for various facets of the implementations. These materials are to be treated as exemplary and are not intended to limit the scope of the invention.

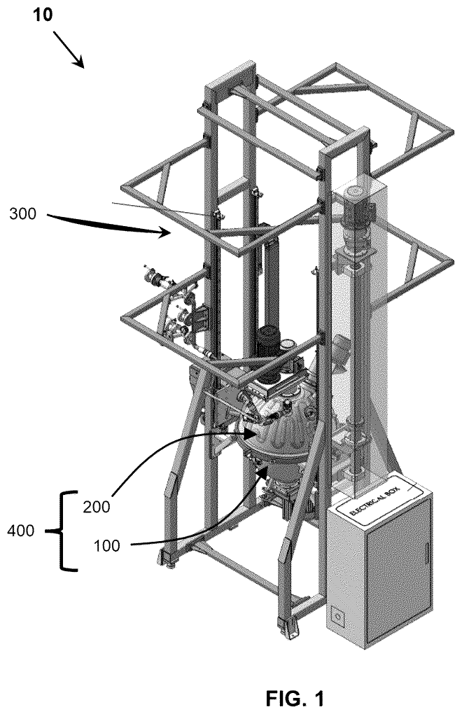

FIG. 1 illustrates an apparatus (10) for complete treatment of slurry and powder, in accordance with an embodiment of the present invention. The treatment includes one or more operations such as, but not limited to, separation, filtration, drying, milling, sieving and packing including sampling at each stage.

As shown in FIG. 1, the apparatus (10) majorly comprises, but not limited to, a lower bowl assembly (100), an upper bowl assembly (200), a drive and a main frame assembly (300). The main frame assembly (300) movably mounts the lower bowl assembly (100) and the upper bowl assembly (200) coupled together to form a spherical bowl assembly (400) in a vertical orientation. Each of the above mentioned components will now be discussed in detail with reference to accompanying drawings.

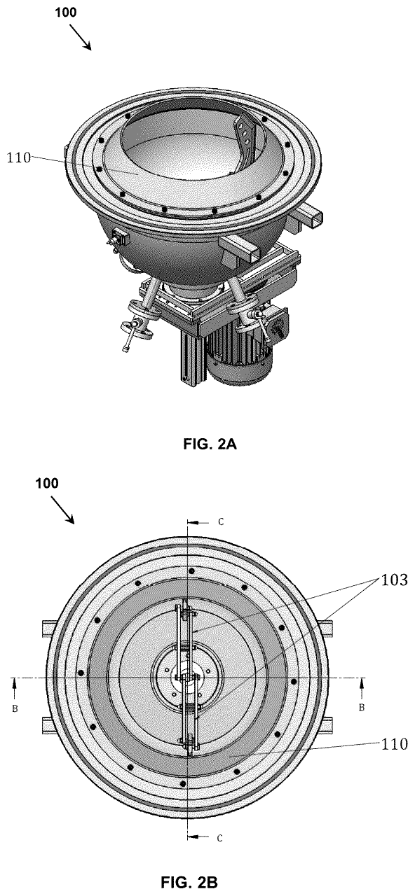

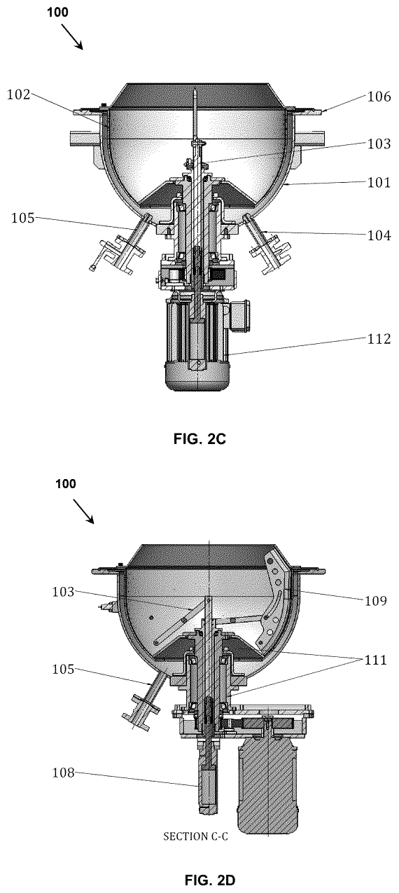

Further, FIGS. 2A-2D illustrate multiple views of the lower bowl assembly, in accordance with an embodiment of the present invention. As can be seen from the drawings, FIG. 2A illustrates a perspective view of the lower bowl assembly; FIG. 2B illustrates a top view of the lower bowl assembly; FIG. 2C illustrates sectional view of section B-B marked on FIG. 2B; and FIG. 2C illustrates sectional view of section C-C marked on FIG. 2B.

Referring to above FIG. 2B-2D, the lower bowl assembly (100) includes, but not limited to, a hemi spherical drain bowl (101) (or simply referred as “a drain bowl (101)”), a hemi spherical filtration bowl (102), a cake cutter (103), a drain nozzle (104), and a utility nozzle (vacuum/nitrogen/any other gas/water etc.) (105). The drain bowl (101) is stationery and has, but not limited to, a hemi spherical shape which houses the hemi spherical filtration bowl (102). The drain bowl (101) is provided with the drain nozzle (104) configured to drain a mother liquor, and the utility nozzle (105) is configured to apply vacuum/Nitrogen/any other gas/water etc., during drying and cleaning. The drain bowl (101) is mounted on the mainframe assembly (not shown here but in shown in first as well as subsequent drawings) with the sideways support. It has quick release flange in the top (106) and is connected to the upper bowl assembly (200) with quick release coupling (not shown in these drawings).

Additionally, the drive includes a first geared motor (112) connected with the filtration bowl (102) and a reciprocating cylinder (108) connected with a cake cutter (103) is mounted on the drain bowl (101). The drain bowl (101) may be provided with insulation and cladding to reduce the heat loss during filtration and drying (currently not shown in the drawing). The drain bowl (101) may also be provided with a heating jacket/limpet coil for heating inside (not shown in the drawing).

Furthermore, the filtration bowl (102) is made up of, but not limited to, a sintered filter with or without a perforated bowl. The filtration bowl (102) may also be manufactured with a bag filter with the perforated bowl. The porosity of the sintered filter or a filter cloth is selected based on the particle size of the solid in the slurry. The filtration bowl (102) is mounted inside the drain bowl (101). Herein, the filtration bowl (102) may made with a slightly lesser diameter than the drain bowl (101) which creates an annular space between drain bowl (101) and filtration bowl (102). The filtration bowl (102) is rotated through the first geared motor (112) mounted on the drain bowl (101). The filtration bowl (102) is designed to rotate at variable speed (generally 0-2900 rpm) depending on the requirement. A top of the filtration bowl (101) is provided with conical canopy (110) to prevent liquid flashing out of the filtration bowl (102) during rotation. The cake cutter (103) is disposed inside the filtration bowl (102), with one or more arms that can move radially. Also, the cake cutter (103) has a cutting blade (109) at the edges to scrape the wet cake deposited on the filtration bowl (102). The cutting blade (109) is operated through the hydraulic or pneumatic reciprocating cylinder (108) mounted on drain bowl (101). The cake cutter (103) is designed to move radially with reciprocating motion of the reciprocating cylinder (108). The radial motion is controlled accurately with a controlled reciprocating motion of the reciprocating cylinder (108). The scraping or cutting action is performed by slow rotation of filtration bowl (102) when the cake cutter blade (109) is moved radially. A bottom of the filtration bowl (102) is provided with a bearing housing, and mechanical seal (111).

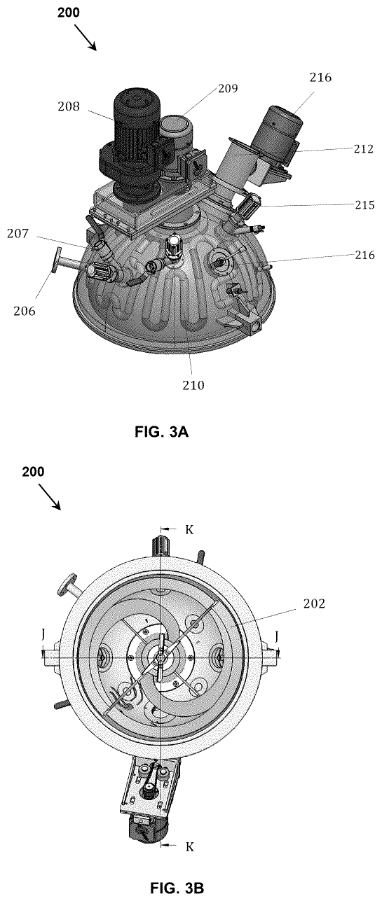

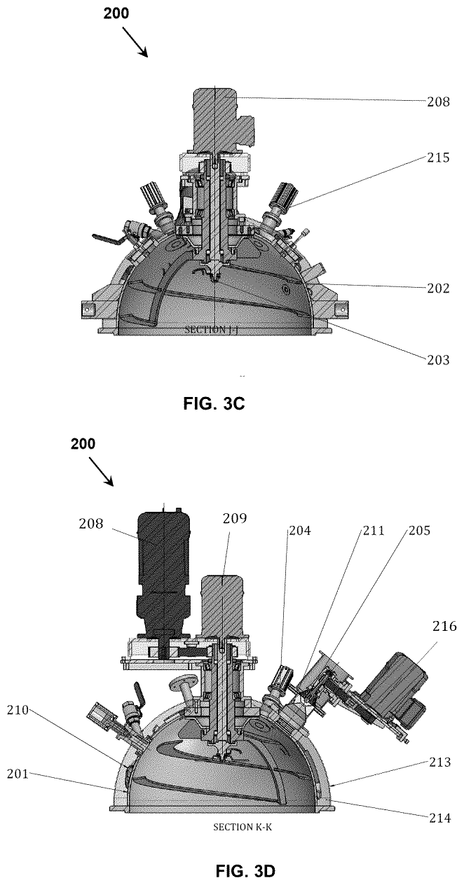

FIG. 3A-3D illustrate multiple views of the upper bowl assembly (200), in accordance with an embodiment of the present invention. It may also be referred to as a drying bowl assembly (200) at some places in the description. As can be seen from the drawings, FIG. 3A illustrates a perspective view of the upper bowl assembly (200); FIG. 3B illustrates a top view of the upper bowl assembly (200); FIG. 3C illustrates sectional view of section J-J marked on FIG. 3B; and FIG. 3C illustrates sectional view of section K-K marked on FIG. 3B.

As can be seen from the FIGS. 3A-3D, the upper bowl or drying bowl assembly (200) has following major components, including, but not limited to, a drying bowl (201), an agitator (202), a chopper (203) also called as delumper, a discharge nozzle (204), a comill (rotary mill cum sifter) (205), and utility nozzles such as nitrogen or vacuum or any other gas/water nozzle (206) and sampling nozzle (207). Herein, the chopper (203) is driven by a second gear motor (209) and agitators (202) are driven by a suitable third geared motor (208) mounted outside the drying bowl (201). Additionally, the comill (rotary mill cum sifter) (205) is configured to be driven by a fourth geared motor (216). They are designed to rotate at required variable speeds. The drying bowl (201) with agitator (202) is designed for complete discharge of dried product. The agitator (202) is designed to push the dried material towards the discharge nozzle (204) during the discharge operation. An outer side of the drying bowl (201) is provided with a jacket or limpet coil (210), which can be used to circulate heating or cooling liquid media. The jacket or limpet coil (210) is covered with outer cladding bowl (213) with insulation (214). The sampling valve (207) is provided in the drying bowl (201) to take out the sample for analysis to confirm the product quality. There may be various other nozzles such as slurry feed, vacuum, nitrogen, hot water in and out, light, sight, spray nozzle, cleaning in place etc provided on the drying bowl (201). A Larger discharge nozzle (204) provided at suitable angle. A suitable discharge valve (211) is provided at the discharge nozzle (204) to control a product discharge rate. The discharge valve (211) is attached with comill (205) rotary miller cum sifter, which is inturn connected with the fourth geared motor (216). At the outlet of the comill (205), an attachment to connect the continuous liner called continuous liner port (212) is provided. The drying bowl (201) and the drain bowl (101) are attached together using a quick release coupling (not shown in these drawings).

The discharge nozzle (204) of the upper bowl assembly (200) is positioned for easy discharge, typically 80-200 mm diameter size. The comill (205) is positioned on this discharge nozzle (204). The comill (205) only runs during discharge. Then, there is a flush bottom type discharge valve (211) provided at the comill (205) and at sampling port (207), charging nozzles etc to avoid dead zone. The agitator (202) is used for moving, pressing the wet mass during drying. The agitator (202) is driven by the third geared motor (208) 5-100 rpm on variable speed. The chopper (203) is designed for de-lumping of the wet mass. The chopper r (203) is mounted on the drying bowl (200) and is run by second geared motor (209) at 200-1000 rpm variable speed. Additionally, a view glass (216) and a digital camera system may be provided for checking of the complete discharge of the dried product.

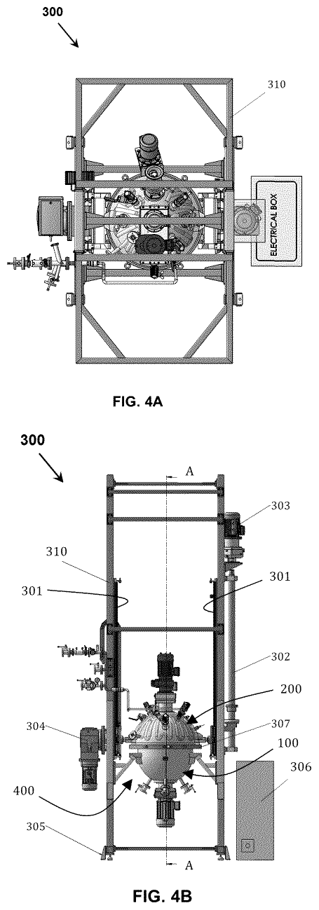

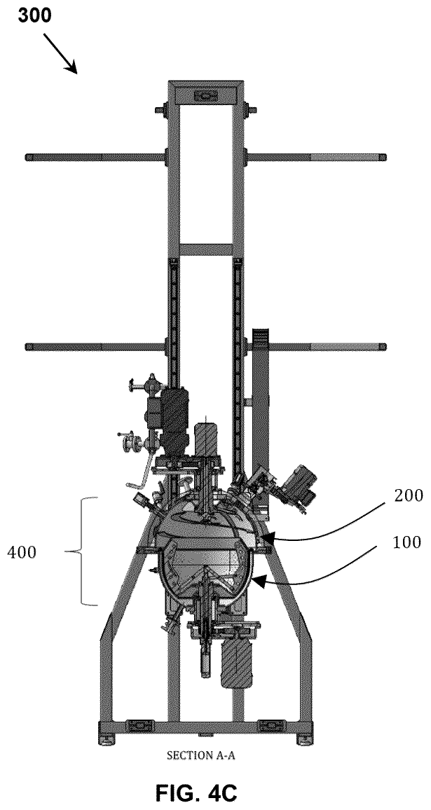

FIG. 4A-4C illustrate multiple views of the main frame assembly (300), in accordance with an embodiment of the present invention. As can be seen from the drawings, FIG. 4A illustrates a top view of the main frame assembly (300); FIG. 4B illustrates a front view of the main frame assembly (300); and FIG. 4C illustrates sectional view of section A-A marked on FIG. 4B.

As shown in FIG. 4A-4C, the main frame assembly (300) may understood as a lifting, positioning & rotating device. The main frame assembly (300) includes a main frame (310), which mounts an LM guide (301) and a lead screw (302). The lead screw (302) is driven by a fifth geared motor (303). The LM guide (301) and the lead screw (302) along with the fifth geared motor (303) is connected to the upper bowl assembly (200). When upper bowl (200) and lower bowls (100) are coupled, entire assembly can move up and down on the main frame (310). The lead screw (302) is also designed to lift the drying bowl (201) of the upper bowl assembly (200), independently of the drain bowl (101) of the low bowl assembly (100). A sixth geared motor (304) is also provided on the main frame (310) (on opposite side of the fifth geared motor), and is connected to the lower bowl assembly (100). The sixth geared motor (304) is designed to rotate the spherical bowl assembly (400) (i.e. the upper bowl assembly (100) and the lower bowl assembly (200) together) along its axis at low speed. Additionally, weight measuring load cells (305) are provided at a bottom of the main frame (310) for measuring of weight of the spherical bowl assembly (400). A control panel (306) is also provided with a programmable logic. Moreover, The cleaning spray ball assembly is provided inside to wash the entire bowl assembly. Flow meter may be provided in the slurry line and also in the drain line.

In accordance with an embodiment of the present invention, all contact parts and non-contact parts shall be made of, but not limited to, stainless steel or the like. For example: the contact parts may be made of, but not limited to, SS316 and all the non-contact parts may be made of, but not limited to, SS304. Apart from this, the gaskets may be made from a material selected from, but not limited to, be PTFE, PFA, FEP or Viton.

A Method of Working of the apparatus (10) (i.e. a process of complete treatment the slurry):

The present invention operates in the following exemplary manner. Referring to FIGS. 1 and 4A-4C, for starting the operation the lower bowl assembly (100) and the upper bowl assembly (200) are first brought to the bottom most position and the drying bowl (201) is clamped over the drain bowl (101) firmly using the quick release coupling (307). The assembly of all the bowls (i.e. the spherical bowl assembly (400) thus formed) shall be in a vertical position. All the valves and nozzles are closed. The nitrogen is fed into the apparatus (10) to ensure inertisation inside. Then, the filtration bowl (102) is rotated at low or medium speed, while the slurry is slowly fed into it through the slurry feed nozzle (215). Due to the rotation of the filtration bowl (102), a centrifugal force is generated on the slurry. The centrifugal force pushes the slurry towards the wall of the filtration bowl (102). Due to centrifugal force, the solid and the liquid get separated, the filtrate passes through the filter, and flows out of the filtration bowl (102) into the drain bowl (101). The filtrate collected in the drain bowl (101) is then drained out through drain nozzle (104). The conical canopy (110) provided on the filtration bowl (102) prevents the slurry slipping out of the filtration bowl (102) during rotation. The solids in the form of wet cake start getting collected in a layer by layer form on the inside surface of the filtration bowl (102). The slurry may be fed into the filtration bowl (102) till optimum cake thickness is achieved. The filtration bowl (102) will continue to rotate till the maximum filtration is achieved. Then, the wet cake may be given washing with a solvent and again the filtration bowl (102) is rotated at low or medium speed. The maximum amount of wash solvent is removed from the wet cake by centrifugation at low speed rotation. Once majority of the filtrate/wash liquid is removed, the filtration bowl (102) is spun at a higher or full speed. Higher the rotary speed, higher is the centrifugal force. Once the maximum possible amount of filtrate is removed from the solids, the filtration bowl (102) is brought to a very low speed. While moving the filtration bowl (102) with very low speed, the cake cutter (103) is moved slowly radially outward position to scrape the cake. The slow rotating action of the filtration bowl (102) scrapes the cake, layer by layer. Once the cake is fully scraped and loosened by cutter, the rotation of the filtration bowl (102) is stopped. During the process, the venting is kept open, nitrogen blanketing is maintained, and draining is done continuously. The weight of the spherical bowl assembly (400) is continuously monitored through the load cells. The increase and decrease in the weight gives an indication of the quantity of the slurry pumped, a quantity of the cake and an amount of filtrate drained. This data can be used for calculating a dryness of the wet cake.

Then the spherical bowl assembly (400) (filtration bowl, drain bowl and drying bowl together) is rotated 180 degrees, (along its axis making the spherical bowl assembly (400) upside down) thus bringing the drain bowl (101) to the upper position and the drying bowl (201) to the bottom position. In this position, the wet cake gets dumped or unloaded from the filtration bowl (102) into the drying bow (201). During this time, the drying bowl (201) is kept heated with hot water circulation in the jacket/limpet coil (210). The agitator (202) and the chopper (203) is also started simultaneously. This ensures that the wet mass is heated, agitated, and the lumps are chopped. The agitator (202) is designed to ensure the material is slowly moved up and down, and mixed inside the drying bowl efficiently, slowly and gently. The chopper (203) is designed to ensure that any lump in the material is delumped or chopped into smaller pieces. The chopper is designed for the purpose of deaglomeration of the lumps. The vapour/vacuum nozzle is kept open to remove vapour generated while drying, nitrogen blanket is maintained. The vapour nozzle can also be connected to a vacuum source. The vacuum inside the drying bowl will reduce the boiling temperature of the solvent so that the drying takes place quickly and effectively. The rotation speed of the chopper (203) will depend on the type of the lump to be broken (hard or soft). A speed of agitator (202) will depend on the product to be dried.

The sample is taken out for quality analysis through the sampling valve (207). Furthermore, when the product is dried, the product in the drying bowl (201) is ready for further process, the entire assembly is now lifted slightly upwards to suitable height, rotated and positioned such a way that the discharge nozzle (211) is positioned vertically downwards. The comill (205) attached to the discharge nozzle will now come in downward direction. The continuous liner bag is now attached to the continuous liner port (212) at the outlet of the comill. Weighing balance is now placed below the continuous liner bag. The chopper (203) is stopped. The agitator (202) is kept rotated at low speed. The comill (205) is then started while slowly opening discharge valve (211). The dried product starts flowing out into the comill (205) through the discharge valve (211). The milled and sifted powder starts flowing out into the continuous liner port (212) and into continuous liner bag. The powder discharged into continuous liner system is weighed and packed, in completely closed and contained manner without exposure to the operator or to the environment.

Once the dried powder is completely unloaded, the equipment shall be washed with suitable solvent. The cleaning liquid is sprayed using the spray ball provided. The digital camera system along with view glass (216) are used for checking the cleanliness or any debris. The digital camera system may also be used for monitoring and controlling the complete process inside. The solvent may be drained through the drain valve (204) and the equipment may be dried with nitrogen. A product sample may be taken at wet and also at dry condition for analysis. The apparatus has been designed with required instruments to measure and control the temperature, pressure, inertisation, humidity of product. Also, the suitable instruments are provided to measure and control the speed, load and torque of all the motors. Suitable weight measuring instruments are provided to the main frame to continuously monitor the weight, quantity, flow etc., of the slurry, wet cake, dried powder and empty weight of the equipment.

In accordance with the embodiment of the present invention, the system is provided with instruments such as flowmeter, torque and weight measurement. A provision for autoleak test of the assembly is lso provided in the system.

In accordance with an embodiment of the present invention, all the rotary joints may have, but not limited to, mechanical seal or suitable arrangement for pressure hold.

In accordance with an embodiment of the present invention, the apparatus (10) may also be provided with various instrumentation for, but not limited to:
Torque measurement and torque adjustment to suite the required torque, during centrifugation and during drying and milling & sieving
RPM measurement and control for Centrifugation, Drying and Milling & Sieving
Temperature measurement of inside material and jacket temperature measurement. During centrifugation, drying cycle and milling & sieving cycle.
Pressure measurement and pressure relief system
Pressure safety system
Static current measurement and discharge. Electric Continuity monitoring
Continuous weight measurement and monitoring
Humidity measurement, Moisture measurement
Light and view
Camera for inside view
Vessel rotation measurement
Auto Sampling during the various stages
Drying confirmation
Centrifuging confirmation
Vibration monitoring during centrifugation, drying and milling & Sieving operation
Flow control for centrifuge charging. Level or quantity sensing for Centrifuge
Flow control through valve of powder for Milling & Sieving Charging
Mechanical seal, bearing temperature monitoring
SIP and CIP Cleaning cycle development
Retractable spray nozzle and control
Inertisation by Nitrogen. Oxygen level monitoring. Nitrogen Purging for vacuum breaking.

In accordance with another embodiment of the present invention, the apparatus (10) may be provided with the following features:
IPC SCADA based system shall be provided for control.
SIP & CIP with complete drain ability. CIP for Vent filter
Vapour venting and controlling dust escape. Vent filter arrangement. Condensate with dust collection shall be provided.
Residue free discharge
Design for Full Vacuum, Pressure, high RPM Centrifugal force, high temperature
Dry gas purging during drying
Release of residual pressure during CF and Drying
Self-determination of torque required and adjusting for the required torque
Various interlock shall be built in for safety.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and the appended claims.

1. An apparatus for complete treatment of slurry and powder, the apparatus comprising:
a rotatable lower bowl assembly;
an upper bowl assembly adapted to be assembled with the lower bowl assembly;
a drive including atleast a geared motor, connected with each of the lower bowl assembly and the upper bowl assembly; and
a main frame assembly to movably mount the lower bowl assembly and the upper bowl assembly coupled together to form a spherical bowl assembly in a vertical orientation;
wherein the spherical bowl assembly is adapted to receive the slurry for treatment via the lower bowl assembly, processing the slurry into a dried product after treatment, and discharge the dried product out of the spherical bowl assembly in a completely closed and contained manner without any exposure to the operator or to the environment.

2. The apparatus of claim 1, wherein the lower bowl assembly includes a drain bowl, a filtration bowl, a cake cutter, a drain nozzle, and a utility nozzle,
wherein the drain bowl is mounted on the mainframe assembly and is adapted to house the filtration bowl;
wherein the drain bowl is provided with the drain nozzle configured to drain a mother liquor, and
wherein the utility nozzle is configured to apply vacuum or Nitrogen, during drying and cleaning.

3. The apparatus of claim 2, wherein the drive associated with lower bowl assembly (100) includes a first geared motor connected with the filtration bowl and a reciprocating cylinder connected with a cake cutter is mounted on the drain bowl;
wherein the first geared motor is configured to rotate the filtration bowl at variable speeds depending on the requirement;
wherein the cake cutter has a cutting blade at edges to scrape the wet cake of solids separated from slurry, deposited on the filtration bowl;
wherein the cake cutter is configured to move radially with reciprocating motion of the reciprocating cylinder and the scraping or cutting action is performed by a slow rotation of filtration bowl when the cake cutter blade is moved radially.

4. The apparatus of claim 1, wherein the upper bowl assembly includes a drying bowl, an agitator, a chopper, a discharge nozzle, a comill and utility nozzles selected from a nitrogen or vacuum nozzle and a sampling nozzle;
wherein the drying bowl together with the agitator is designed for complete discharge of a dried product, whereby the agitator is configured to press the wet mass during drying operation and push the dried material towards the discharge nozzle during the discharge operation;
wherein the chopper is configured to be driven by a second gear motor and the agitators are configured to be driven by a third geared motor mounted outside the drying bowl at variable speeds;
wherein a discharge valve is provided at the discharge nozzle to control a product discharge rate.

5. The apparatus of claim 4, wherein the upper bowl assembly comprises a view glass and a digital camera system may be provided for checking of the complete discharge of the dried product.

6. The apparatus as claimed in claim 1, wherein the main frame assembly includes a main frame, that mounts an LM guide, and a lead screw;
wherein the lead screw is adapted to be driven by a fifth geared motor;
wherein the LM guide and the lead screw along with the fifth geared motor are connected to the upper bowl assembly;
wherein when upper bowl and lower bowls are assembled together, the entire spherical bowl assembly is enabled to move up and down on the main frame;
wherein the lead screw is also configured to lift the drying bowl of the upper bowl assembly, independently of the drain bowl of the lower bowl assembly.

7. The apparatus of claim 6, wherein a sixth geared motor is also provided on the main frame on an opposite side of the fifth geared motor, and is connected to the lower bowl assembly;
wherein the sixth geared motor is designed to rotate the spherical bowl assembly along its axis at low speed;
wherein weight measuring load cells are provided at a bottom of the main frame for measuring of weight of the spherical bowl assembly.

8. The apparatus of claim 7, comprising:
a control panel provided with a programmable logic;
a cleaning spray ball assembly provided to wash the entire spherical bowl assembly;
a flow meter provided in a slurry line and also in a drain line.

9. A process for complete treatment of slurry and powder using, comprising:
assembling the drying bowl over the drain bowl firmly using the quick release coupling, to form the spherical bowl assembly in a vertical orientation;
moving the spherical bowl assembly in the vertical orientation to the bottom most position on the main frame;
closing all the valves and feeding nitrogen inside the spherical bowl assembly to ensure inertisation;
rotating the filtration bowl at low or medium speed, while feeding the slurry into it;
pushing the slurry towards the wall of the filtration bowl and separating it into solids and liquids, under an influence of a centrifugal force generated by rotation;
causing the liquid filtrate to flow out of the filtration bowl into the drain bowl and then drained out through drain nozzle;
causing the solids to form a wet cake start getting collected in a layer by layer form on an inside surface of the filtration bowl;
adding a solvent in the filtration bowl while rotating at low speed to wash the wet cake and then draining the solvent out of the filtration bowl after washing; and
moving the filtration bowl at very low speed to allow the cake cutter disposed therein to move slowly and radially outward to scrape the wet cake in a layer by layer manner.

10. The process of claim 9, comprising:
rotating the spherical bowl assembly upside down, thereby bringing the drain bowl to the upper position and the drying bowl to the bottom position;
dumping or unloading the wet cake from the filtration bowl into the drying bow;
heating the drying bowl with hot water circulation in the jacket or limpet coil and simultaneously starting the agitator and the chopper to ensure that the wet mass of the cake is heated, agitated, and the lumps are chopped;
opening a vacuum nozzle to remove vapour generated during drying, while maintaining a nitrogen blanket;
ensuring a vacuum inside the drying bowl to reduce the boiling temperature of the solvent so that the drying takes place quickly and effectively, to form a dried product;
lifting the spherical bowl assembly is upwards to a predetermined height on the main frame, rotated and positioned in a way that the discharge nozzle is positioned directly downwards;
starting the comill while slowly opening the discharge valve to cause the dried product to flow out into the comill through the discharge valve; and
collecting the discharged product in powdered form in a continuous liner bag for weighing and packing, thereby completing the treatment of slurry in a completely closed and contained manner without any exposure to the operator or to the environment.
